(19) United States
(12) Patent Application Publication
(10) Pub. No.: US 2018/0290865 A1
(43) Pub. Date: Oct. 11, 2018

(54) Small Engine Transporter Device

(71) Applicant: George J. Banks, Conneautville, PA (US)

(72) Inventor: George J. Banks, Conneautville, PA (US)

(21) Appl. No.: 15/573,933

(22) PCT Filed: May 16, 2016
(86) PCT No.: PCT/US16/32786

§ 371 Date: Nov. 14, 2017

Related U.S. Application Data
(60) Provisional application No. 62/161,499, filed on May 14, 2015.

(51) Int. Cl. B66C 23/48; B66C 23/00; B66C 1/44

(52) U.S. Cl. CPC B66C 23/485; B66C 2700/0357; B66C 1/44; B66C 23/54

(57) ABSTRACT

A small engine transport device for moving small engines comprises a plurality of adjustable arms sized and configured for receiving a vehicle engine and legs configured to counter-balance the adjustable arms when the adjustable arms are bearing the weight of a vehicle engine. Each adjustable arm may have a hand to bear against a vehicle engine. A hydraulic jack could be used to adjust the vertical position of the adjustable arms when bearing the weight of a vehicle engine. The adjustable arms and/or the legs could be foldable to lower the profile of the small engine transport device for storage.

This application takes priority from U.S. Provisional Patent Application No. 62/161,499, incorporated herein by reference.

### BACKGROUND

Engines in small vehicles, such as motorcycles, are sometimes required to be removed from the vehicle for repair, maintenance, or otherwise. Typically, this is done by hand, or by a complicated series of chains and pulleys. Either method involves significant risk of injury to the mechanic and often requires multiple mechanics to safely maneuver a heavy engine without dropping it and causing injury to the mechanic or damage to the engine. What is presented is a transporter device that is sized and configured to allow a single mechanic the ability to remove, move, and remount an engine from a vehicle such as a motorcycle.

### SUMMARY

What is presented is a small engine transport device for moving small engines. The small engine could be configured to accommodate any of a variety of vehicles including motorcycles, tractors, motor scooters, go-karts, quads, trikes, etc. The small engine transport device comprises a plurality of adjustable arms sized and configured for receiving a vehicle engine. Legs are configured to counter-balance the adjustable arms when the adjustable arms are bearing the weight of a vehicle engine. Some embodiments of the small engine transport device may have hands on each adjustable arm to bear against a vehicle engine. In other embodiments of the small engine transport a hydraulic jack could be incorporated to adjust the vertical position of the adjustable arms when bearing the weight of a vehicle engine.

The legs of the small engine transport device may comprise wheels to enable the device to move while bearing the weight of a vehicle engine. Some other locomotion device may also be used. The adjustable arms may also be interchangeable to accommodate different engine and vehicle configurations.

In various embodiments, of the small engine transport device the adjustable arms and/or the legs are foldable to lower the profile of the device for storage.

Those skilled in the art will realize that this invention is capable of embodiments that are different from those shown and that details of the apparatus and methods can be changed in various manners without departing from the scope of this invention. Accordingly, the drawings and descriptions are to be regarded as including such equivalent embodiments as do not depart from the spirit and scope of this invention.

### BRIEF DESCRIPTION OF DRAWINGS

For a more complete understanding and appreciation of this invention, and its many advantages, reference will be made to the following detailed description taken in conjunction with the accompanying drawings.

FIG. 1 shows a perspective view of a small engine transporter device positioned next to a motorcycle;

FIG. 2 shows a side view of the small engine transporter device of FIG. 1 positioned next to the motorcycle;

FIG. 3 shows a side view of the small engine transporter device of FIG. 1 positioned to receive the engine of the motorcycle;

FIG. 4 shows a side view of the small engine transporter device of FIG. 1 positioned next to a motorcycle but bearing the engine of the motorcycle in its adjustable arms;

FIG. 5 shows a side view of the small engine transporter device of FIG. 1 bearing the engine of the motorcycle in its adjustable arms; and

FIG. 6 shows a side view of the small engine transporter device of FIG. 1 folded for storage.

### DETAILED DESCRIPTION

Referring to the drawings, some of the reference numerals are used to designate the same or corresponding parts through several of the embodiments and figures shown and described. Corresponding parts are denoted in different embodiments with the addition of lowercase letters. Variations of corresponding parts in form or function that are depicted in the figures are described. It will be understood that variations in the embodiments can generally be interchanged without deviating from the invention.

Repairing or maintaining the engines of small vehicles such as motorcycles, tractors, motor scooters, go-karts, quads, or trikes, sometimes requires the mechanic to remove the engine from the vehicle in order to access hard to reach components. Other times, the mechanic may simply wish to remove a vehicle engine and replace it with another. In any case, small engines still weigh a considerable amount and dismounting the engine from the vehicle frame and moving it requires considerable effort for single mechanic.

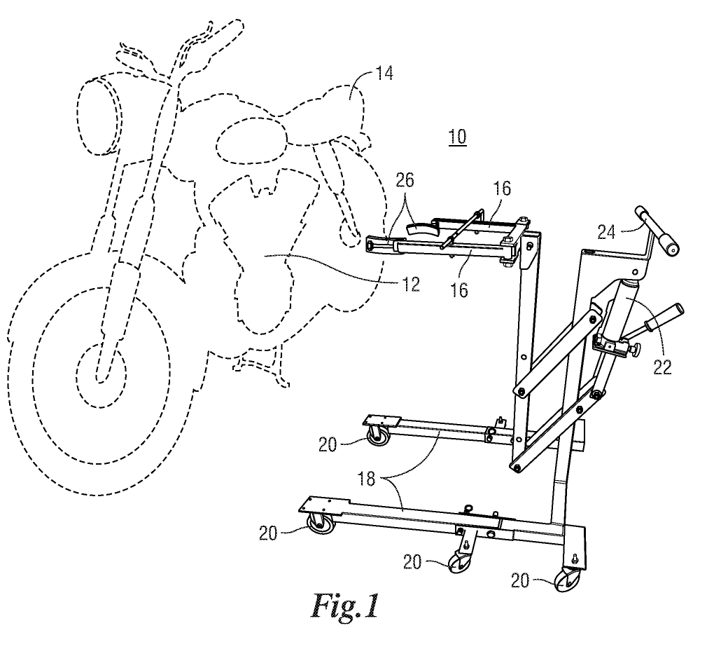

FIG. 1 shows an embodiment of small engine transport device 10 that makes it easier to dismount and move an engine 12 from a vehicle 14. The small engine transport device 10 shown has adjustable arms 16 that are configured to fit within the frame of the vehicle 14 such that the adjustable arms 16 can bear the weight of the engine 12 when the engine 12 is dismounted from the frame of the vehicle 14. Each adjustable arm 16 has a hand 26 that supports the engine 12 when it is mounted to the small engine transport device 10. The hands 26 may be cushioned to minimize damage or scratching of the engine 12 or vehicle 14 components.

The small engine transport device 10 has legs 18 that are configured to counter balance the adjustable arms 16 when bearing the weight of the engine 12. The legs 18 are mounted on wheels 20 that allow the entire small engine transport device 10 to move while bearing the weight of an engine 12. A hydraulic jack 22 is shown in this embodiment that is used to adjust the vertical position of the adjustable arms 16. This is particularly useful when the adjustable arms 16 are bearing the weight of an engine 12. The entire small engine transport device 10 can be maneuvered with the assistance of the handle bars 24.

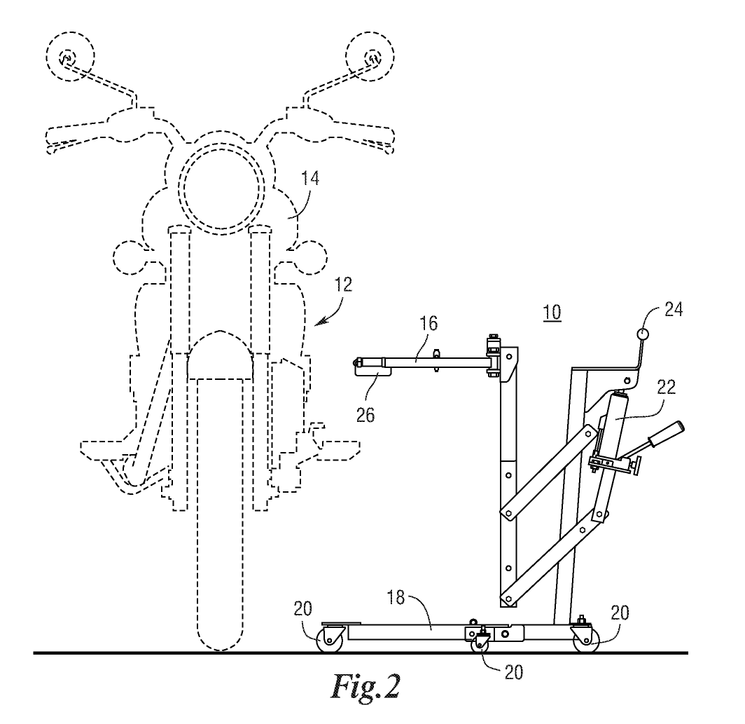

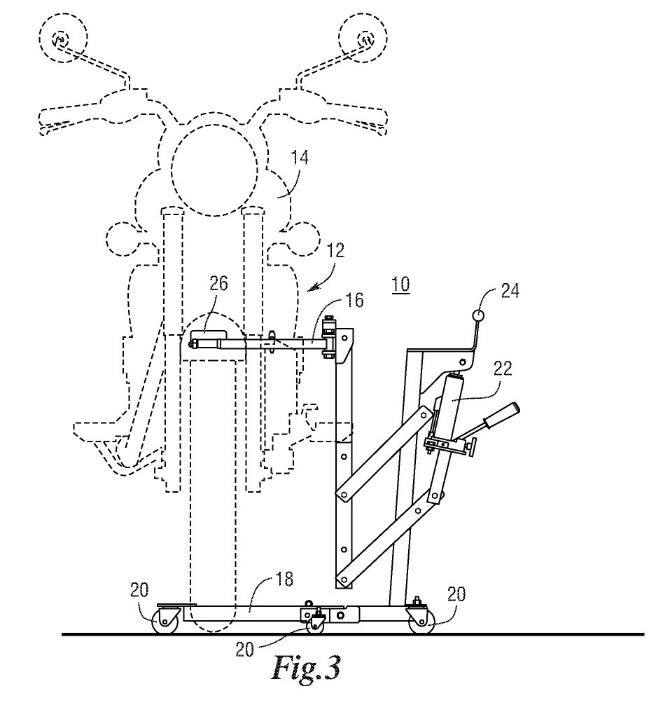

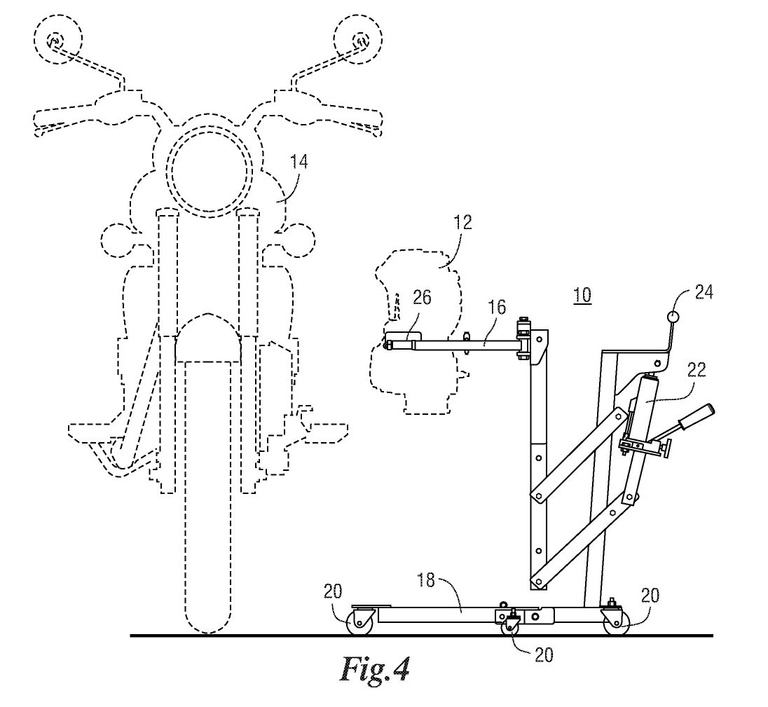

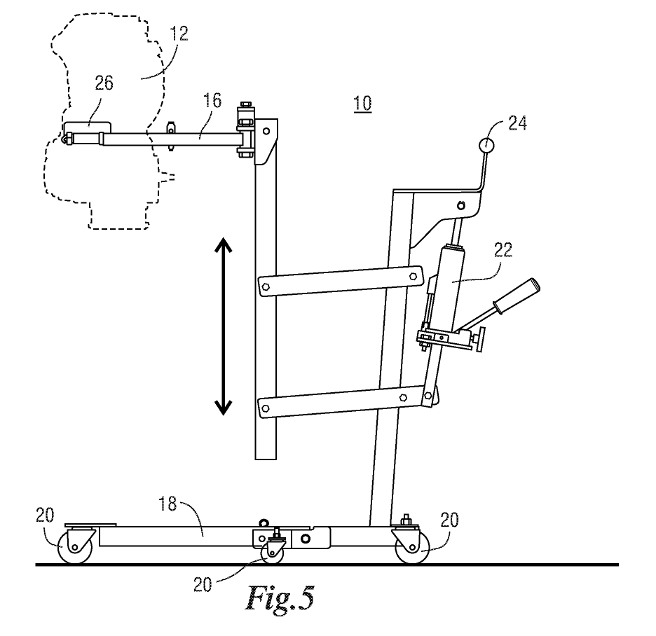

As can be best understood by viewing FIGS. 2 through 5 in succession, the small engine transport device 10 is used by first adjusting the adjustable arms 16 to fit within the frame of the vehicle 14 ready to bear the weight of the engine 12. The small engine transport device 10 is moved into position and the hands 26 are positioned at appropriate locations on the engine 12 so that they can support the engine 12. The hydraulic jack 22 is raised such that the hands 26 and adjustable arms 16 bear some portion of the weight of the engine 12. The engine 12 can then be dismounted from the vehicle 14 frame. The hydraulic jack 22 is adjusted, if necessary, to slightly lower the adjustable arms 16 and the entire small engine transport device 10 can be moved out from the vehicle 14 frame. This gives mechanics full access to the engine 12 and the engine support structure of the vehicle 14. Once work on the engine 12 or the vehicle 14 is complete, the small engine transport device 10 is moved back to the vehicle 14 frame. If necessary, the hydraulic jack 22 is actuated to position the adjustable arms 16 and the engine 12 within the vehicle 14 frame. The engine 12 is remounted to the vehicle 14 and once secure, the small engine transport device 10 can be retracted.

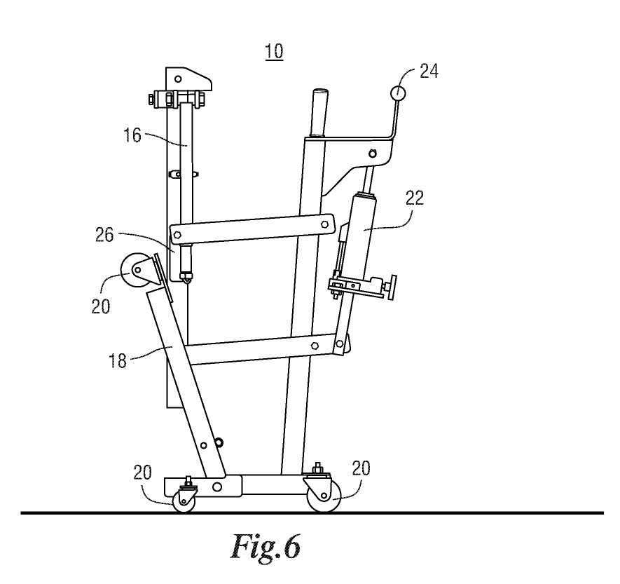

FIG. 6 shows that the small engine transport device 10 can be folded when not in use for storage or transport. The handle of the adjustable arms 16 are folded downwards and the legs 18 are folded upwards to reduce the profile of the small engine transport device. In this embodiment, the handle of the hydraulic jack 22 is disengaged from the hydraulic jack 22 and repositioned on the frame of the small engine transport device 10 to further reduce the profile. It will be appreciated that other folding configurations are also feasible.

In some embodiments, not shown, the adjustable arms could be interchangeable to fit vehicles of different configuration or to support different types of engines. The number and location of the adjustable arms is also variable such that some embodiments could comprise more than two adjustable arms as may be required for particularly cumbersome engine or vehicle configurations. In addition, the number and configuration of wheels on the legs shown in the figures may be varied in different embodiments. In addition, the type of locomotion device may be something other than wheels so long as they are capable of bearing the weight of the small engine transport device while it is supporting an engine.

This invention has been described with reference to several preferred embodiments. Many modifications and alterations will occur to others upon reading and understanding the preceding specification. It is intended that the invention be construed as including all such alterations and modifications in so far as they come within the scope of the appended claims or the equivalents of these claims.

1. A small engine transport device for moving small engines comprising:
a plurality of adjustable arms sized and configured for receiving a vehicle engine;
legs configured to counter-balance said adjustable arms when said adjustable arms are bearing the weight of a vehicle engine.

2. The small engine transport device of claim 1 further comprising each said adjustable arms having a hand to bear against a vehicle engine.

3. The small engine transport device of claim 1 further comprising a hydraulic jack for adjusting the vertical position of said adjustable arms when bearing the weight of a vehicle engine.

4. The small engine transport device of claim 1 further comprising each said legs further comprising wheels to enable the device to move while bearing the weight of a vehicle engine.

5. The small engine transport device of claim 1 further comprising said adjustable arms are interchangeable to accommodate different engine and vehicle configurations.

6. The small engine transport device of claim 1 further comprising said adjustable arms are foldable to lower the profile of the device for storage.

7. The small engine transport device of claim 1 further comprising said legs are foldable to lower the profile of the device for storage.

8. The small engine transport device of claim 1 which is configured to accommodate any one of a motorcycle, a tractor, a motor scooter, a go-kart, a quad, or a trike.
